(19) United States
(12) Patent Application Publication
(10) Pub. No.: US 2016/0307665 A1
(43) Pub. Date: Oct. 20, 2016

(54) COATING METHODS USING SILVER NANOPARTICLES

(71) Applicant: Xerox Corporation, Norwalk, CT (US)

(72) Inventors: Yiliang Wu, Menlo Park, CA (US); Ping Liu, Mississauga (CA); Nan-Xing Hu, Oakville (CA)

(73) Assignee: Xerox Corporation, Norwalk, CT (US)

(21) Appl. No.: 15/190,949

(22) Filed: Jun. 23, 2016

Related U.S. Application Data
(62) Division of application No. 13/107,188, filed on May 13, 2011.

(51) Int. Cl. H01B 3/44; C23C 26/00; H01B 3/40; H01B 3/42; H01B 3/30; C23C 24/00; H01B 1/02

(52) U.S. Cl. CPC H01B 3/44; C23C 24/00; C23C 26/00; H01B 1/02; H01B 3/426; H01B 3/441; H01B 3/421; H01B 3/305; H01B 3/306; H01B 3/40

(57) ABSTRACT

Methods for coating wires to apply a silver cladding are disclosed herein. Silver nanoparticles are dispersed in a low surface tension solvent to form a coating solution. A wire is drawn through the coating solution to form a coating layer of silver nanoparticles on the wire. The coating layer is then annealed to form the wire with a silver cladding thereon.

### CROSS-REFERENCE TO RELATED APPLICATIONS

This application is a divisional of U.S. patent application Ser. No. 13/107,188, filed May 13, 2011. The disclosure of this application is hereby fully incorporated by reference herein.

### BACKGROUND

The present disclosure relates to silver nanoparticle compositions and methods for using such compositions to coat long flexible objects with small cross-sections such as wires, fibers, and filaments. Included are such objects that are used to conduct a current, objects that are used for decoration, and objects that are used for acoustic applications. Also disclosed herein are the coated/clad wires, fibers, and/or filaments formed by such methods and compositions.

Several applications, such as electronic switches and connectors, use solid silver wires (i.e. wires consisting entirely of silver). This is due to silver's high conductivity and low contact resistance. However, silver is a relatively expensive metal. For these reasons and others, it would be desirable to provide silver coated wires, fibers, and/or filaments which have equivalent or improved properties and/or reduced cost.

Several applications use plastic wires which are transparent or colorless. Cladding these wires with silver will enhance their visual appearance, or increase the density of the wires for special applications.

### BRIEF DESCRIPTION

Disclosed in various embodiments are methods for cladding long, flexible objects with small cross-sections, such as wires, fibers, or filaments. A solution having a low surface tension and containing silver nanoparticles is used. The low surface tension characteristic can be obtained by using either a low surface tension solvent or silver nanoparticles with a low polarity surface. The object is drawn through the solution to form a coated object. The coated object is then annealed to form a cladding thereon.

Disclosed in embodiments is a process for forming a cladding on an object. A silver nanoparticle composition comprising silver nanoparticles and a low surface tension solvent is received. The object is drawn through the silver nanoparticle composition to form a coated object. The coated object is then annealed to form the cladding thereon.

The object may be flexible and have a small cross-section. In particular, a ratio of the cross-section to the length of the object is 2 or less.

The silver nanoparticles may have a topcut of 20 nanometers or less, and a particle size distribution of 5 nanometers or less.

The annealing may occur at at a temperature of 180° C. or less for a period of from about 0.01 minute to about 60 minutes. In specific embodiments, the annealing occurs a temperature of from about 100° C. to about 140° C. The annealing may occur for a period of from about 5 minutes to about 35 minutes.

The process may further comprise applying a receiving layer prior to coating the silver nanoparticles, wherein the receiving layer comprises a silane.

The cladding on the object may have a thickness of from about 50 nanometers to about 50 micrometers.

The low surface tension solvent may be selected from the group consisting of decalin, cyclohexane, dodecane, tetradecane, hexadecane, hexadecane, bicyclohexane, and an isoparaffinic hydrocarbon.

The silver nanoparticle composition may contain from about 5 wt % to about 40 wt % of the silver nanoparticles.

The process may further comprise applying an overcoat layer over the silver cladding. In some embodiments, the overcoat layer is a crosslinked polysiloxane, a crosslinked poly(silsesquioxane), or a crosslinked layer comprising poly(vinylphenol) and a melamine-formaldehyde resin.

Disclosed in certain embodiments is a process for forming a cladding on a wire. The wire may be a bare or insulated conductor having a solid, stranded, or twisted construction designed to carry current in an electrical circuit. The wire may also be a plastic wire. A silver nanoparticle composition having a low surface tension is received. The wire is then drawn through the silver nanoparticle composition to form a coating on the wire. The coating is subsequently annealed to form the cladding on the wire.

The wire to be covered with the cladding may be plastic or metal. The metal wire can be, for example, a copper wire, an aluminum wire, a tungsten wire, a silicon wire, and the like. The plastic wire may be made of materials selected from the group consisting of polyester, polyimide, polyamide, polycarbonate, polyacrylate, and polyethylene. It may also be a thin, flexible, continuous length of metal or polymeric material having a circular cross-section. Other wires such as zinc oxide wires can be used as well.

The process may further comprise cleaning the wire prior to drawing the wire through the silver nanoparticle composition.

In particular embodiments, the silver nanoparticle composition has a surface tension of 30 mN/m or less, and comprises a plurality of low polarity silver nanoparticles and a solvent selected from the group consisting of decalin, hexane, dodecane, tetradecane, hexadecane, octadecane, an isoparaffinic hydrocarbon, toluene, xylene, mesitylene, diethylbenzene, trimethylbenzene, tetraline, hexalin, a cyclic terpene, a cyclic terpinene, cyclodecene, 1-phenyl-1-cyclohexene, 1-tert-butyl-1-cyclohexene, methyl naphthalene, and mixtures thereof.

Also disclosed in embodiments is a wire comprising a plastic core, a silver cladding comprising fused silver nanoparticles that surrounds the plastic core, and an optional transparent overcoat layer that surrounds the silver cladding. The ratio of the cross-section to the length of the wire is 2 or less.

In some embodiments, the silver cladding has a thickness of from about 50 nm to about 30 micrometers, and the transparent overcoat layer has a thickness from about 10 nm to about 5 micrometers.

In other embodiments, the plastic core may be made from a material selected from the group consisting of polyester, polyimide, polyamide, polycarbonate, polyacrylate, and polyethylene; the overcoat layer is present, and the overcoat layer is a crosslinked layer comprising poly(vinylphenol) and a melamine-formaldehyde resin.

These and other non-limiting characteristics of the disclosure are more particularly disclosed below.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The following is a brief description of the drawings, which are presented for the purposes of illustrating the exemplary embodiments disclosed herein and not for the purposes of limiting the same.

FIG. 1 is a schematic diagram showing the process of coating a wire of the present disclosure.

FIG. 2 is a cross-sectional view of a wire having a silver cladding and an overcoat layer atop the silver cladding.

FIG. 3 is a picture of a silver-clad plastic wire.

FIG. 4 is a picture of a silver-clad copper wire.

### DETAILED DESCRIPTION

A more complete understanding of the components, processes and apparatuses disclosed herein can be obtained by reference to the accompanying drawings. These figures are merely schematic representations based on convenience and the ease of demonstrating the present disclosure, and are, therefore, not intended to indicate relative size and dimensions of the devices or components thereof and/or to define or limit the scope of the exemplary embodiments.

Although specific terms are used in the following description for the sake of clarity, these terms are intended to refer only to the particular structure of the embodiments selected for illustration in the drawings, and are not intended to define or limit the scope of the disclosure. In the drawings and the following description below, it is to be understood that like numeric designations refer to components of like function.

The term “nano” as used in “silver nanoparticles” indicates a particle size of less than about 1000 nm. In embodiments, the silver nanoparticles have a particle size of from about 0.5 nm to about 1000 nm, from about 1 nm to about 500 nm, from about 1 nm to about 100 nm, and particularly from about 1 nm to about 20 nm. The particle size is defined herein as the average diameter of the silver nanoparticles, as determined by TEM (transmission electron microscopy).

The modifier “about” used in connection with a quantity is inclusive of the stated value and has the meaning dictated by the context (for example, it includes at least the degree of error associated with the measurement of the particular quantity). When used in the context of a range, the modifier “about” should also be considered as disclosing the range defined by the absolute values of the two endpoints. For example, the range “from about 2 to about 4” also discloses the range “from 2 to 4.”

The present disclosure relates to methods of coating an object with a silver cladding. Generally, the object is drawn through a solution of silver nanoparticles which has a low surface tension. The coating of silver nanoparticles formed on the object is then annealed to form a cladding on the object. The object generally has a small cross-section relative to its length; the ratio of the cross-section to the length is 2 or less, including 1 or less, or 0.1 or less, or 0.001 or less. The object is flexible, or in other words can be bent without breaking. The object may have any shape. Exemplary objects here include wires, fibers, and filaments, thin sheets, webs, and other similar items.

The particle size of the silver nanoparticles is determined by the average diameter of the particles. The silver nanoparticles may have an average diameter of about 100 nanometers or less, preferably 20 nanometers or less. In some specific embodiments, the nanoparticles have an average diameter of from about 1 nanometer to about 15 nanometers, including from about 2 nanometers to about 10 nanometers. In addition, the silver nanoparticles have a very uniform particle size with a narrow particle size distribution. The particle size distribution can be quantified using the standard deviation of the average particle size. In embodiments, the silver nanoparticles have a narrow particle size distribution with an average particle size standard deviation of 10 nm or less, including 5 nm or less, or 3 nm or less. In some embodiments, the silver nanoparticles have an average particle size of from about 2 nanometers to about 20 nanometers with a standard deviation of from about 1 nanometer to about 5 nanometers. Without being limited by theory, it is believed that small particle sizes with a narrow particle size distribution make the nanoparticles easier to disperse when placed in a solvent, and can offer a more uniform coating on the object due to the self-assembly of the uniform silver nanoparticles. In embodiments, the silver nanoparticles have a topcut of 20 nanometers or less. As used here, the topcut refers to the largest particle size in the silver nanoparticles.

In embodiments, the silver nanoparticles are composed of elemental silver or a silver composite. Besides silver, the silver composite may include either or both of (i) one or more other metals and (ii) one or more non-metals. Suitable other metals include, for example, Al, Au, Pt, Pd, Cu, Co, Cr, In, and Ni, particularly the transition metals, for example, Au, Pt, Pd, Cu, Cr, Ni, and mixtures thereof. Exemplary metal composites are Au-Ag, Ag-Cu, Au-Ag-Cu, and Au-Ag-Pd. Suitable non-metals in the metal composite include, for example, Si, C, and Ge. The various components of the silver composite may be present in an amount ranging for example from about 0.01% to about 99.9% by weight, particularly from about 10% to about 90% by weight. In embodiments, the silver composite is a metal alloy composed of silver and one, two or more other metals, with silver comprising, for example, at least about 20% of the nanoparticles by weight, particularly greater than about 50% of the nanoparticles by weight.

The silver nanoparticles may be stabilized on their surface by a carboxylic acid or an organoamine. The carboxylic acid generally has from 4 to about 20 carbon atoms. Exemplary carboxylic acids include butyric acid, pentanoic acid, hexanoic acid, heptanoic acid, octanoic acid, nonanoic acid, decanoic acid, undecanoic acid, dodecanoic acid, tridecanoic acid, myristic acid, pentadecanoic acid, palmitic acid, heptadecanoic acid, stearic acid, oleic acid, nonadecanoic acid, icosanoic acid, eicosenoic acid, elaidic acid, linoleic acid, palm itoleic acid, citronellic acid, geranic acid, undecenoic acid, lauric acid, undecylenic acid, isomers thereof, and mixtures thereof. The organoamine may be a primary, secondary, or tertiary amine. The organoamine generally has from 3 to about 20 carbon atoms. Exemplary organoamines include propylamine, butylamine, pentylamine, hexylamine, heptylamine, octylamine, nonylamine, decylamine, undecylamine, dodecylamine, tridecylamine, tetradecylamine, pentadecylamine, hexadecylamine, heptadecylamine, octadecylamine, N,N-dimethylamine, N,N-dipropylamine, N,N-dibutylamine, N,N-dipentylamine, N,N-dihexylamine, N,N-diheptylamine, N,N-dioctylamine, N,N-dinonylamine, N,N-didecylamine, N,N-diundecylamine, N,N-didodecylamine, methylpropylamine, ethylpropylamine, propylbutylamine, ethylbutylamine, ethylpentylamine, propylpentylamine, butylpentylamine, triethylamine, tripropylamine, tributylamine, tripentylamine, trihexylamine, triheptylamine, trioctylamine, 1,2-ethylenediamine, N,N, N′,N′-tetramethylethylenediamine, propane-1,3-diamine, N,N,N′, N′-tetramethylpropane-1,3-diamine, butane-1,4-diamine, and N,N, N′,N′-tetramethylbutane-1,4-diamine, and the like, or mixtures thereof. In specific embodiments, the silver nanoparticles are stabilized with oleic acid or hexadecylamine.

Examples of other organic stabilizers include, for example, those having a formula of X-Y, wherein X is a hydrocarbon group comprising from about 4 to about 24 carbon atoms, and wherein Y is a functional group attached to a surface of the metal nanoparticle and being selected from the group consisting of hydroxyl, amine, carboxylic acid, thiol and its derivatives, xanthic acid, pyridine, pyrrolidone, carbamate and mixtures thereof. In more specific embodiments, X may be a hydrocarbon group having from about 6 to about 18 carbon atoms, from about 8 to about 14 carbon atoms, or from about 10 to about 14 carbon atoms,

Examples of other organic stabilizers include, for example, thiol and its derivatives, —OC(═S)SH (xanthic acid), polyethylene glycols, polyvinylpyridine, polyvinylpyrrolidone, and other organic surfactants. The organic stabilizer may be selected from the group consisting of a thiol such as, for example, butanethiol, pentanethiol, hexanethiol, heptanethiol, octanethiol, decanethiol, and dodecanethiol; a dithiol such as, for example, 1,2-ethanedithiol, 1,3-propanedithiol, and 1,4-butanedithiol; or a mixture of a thiol and a dithiol. The organic stabilizer may be selected from the group consisting of a xanthic acid such as, for example, O-methylxanthate, O-ethylxanthate, O-propylxanthic acid, O-butylxanthic acid, O-pentylxanthic acid, O-hexylxanthic acid, O-heptylxanthic acid, O-octylxanthic acid, O-nonylxanthic acid, O-decylxanthic acid, O-undecylxanthic acid, O-dodecylxanthic acid. Organic stabilizers containing a pyridine derivative (for example, dodecyl pyridine) and/or organophosphine that can stabilize metal nanoparticles may also be used as the stabilizer herein.

In embodiments, the stabilized silver nanoparticles are composed of elemental silver. The stabilized nanoparticles may have a silver content of about 50% or more, including from about 50% to about 90%, preferably from about 60% to about 90% by weight, or from about 70% to about 90% by weight. The content can be analyzed with any suitable method. For example, the silver content can be obtained from TGA analysis or ashing method.

In embodiments, the stabilized silver nanoparticles have a low polarity surface, particularly silver nanoparticles stabilized with an organic stabilizer, such as long-chain carboxylic acids or long-chain organoamine stabilizers. Polarity refers to the dipole-dipole intermolecular forces between the slightly positively-charged end of one molecule to the negative end of another or the same molecule. For example, H₂O is a polar molecule while CH₄ is a nonpolar molecule. In embodiments, the surface of the stabilized silver nanoparticles is composed of low polarity hydrocarbon groups. Polarity affects surface tension, and can be determined by any proper approach. For example, when the stabilized silver nanoparticles were coated as a film, the surface of the film showed a very large advancing water contact angle, indicating a low surface energy and hydrophobic property. In embodiments, the low polarity surface of the silver nanoparticles enables a silver nanoparticle composition having a low surface tension, which ensures an uniform coating of the object.

Silver nanoparticles can be chemically synthesized using various methods known in the art. These chemically synthesized silver nanoparticles generally have a very small and uniform size. For example, silver nanoparticles can be formed by placing a silver compound in a solvent with a stabilizer, heating the mixture, and adding a reducing agent to form the silver nanoparticles. Exemplary synthesis methods can be found in, for example, U.S. patent application Ser. Nos. 12/187,499, 12/193,225, 12/193,203, 12/250,727, 12/331,573, and 12/369, 861, and U.S. Pat. Nos. 7,737,497 and 7,919,015, the disclosures of which are incorporated by reference in their entirety herein.

The silver nanoparticles are dissolved in a solvent to form a silver nanoparticle composition that can be used as a coating solution. Silver nanoparticles are highly soluble in the solvent. In embodiments, the silver nanoparticle composition contains from about 5 weight percent to about 60 weight percent (wt %) of the silver nanoparticles, including from about 5 weight percent to about 40 weight percent of the silver nanoparticle, or from about 8 wt % to about 30 wt %, or from about 10 wt % to about 20 wt %.

Any suitable solvent can be used to dissolve or to disperse the silver nanoparticles, including water, an alcohol, a ketone, an ester, an ether, a hydrocarbon, a heteroatom-containing aromatic compound, and the like. Exemplary alcohols include methanol, ethanol, propanol, butanol, hexanol, octanol, and the like. Exemplary ketones include acetone, acetophenone, butanone, ethyl isopropyl ketone, methyl isopropyl ketone, 3-pentanone, and mesityl oxide. Exemplary esters include ethyl acetate, methyl acetate, butyl acetate, ethyl lactate, diethyl carbonate, and dioctyl terephthalate. Exemplary ethers include tetrahydrofuran, tetrahydropyran, morpholine, dioxane, dimethoxyethane, and methoxyethane. Exemplary heteroatom-containing aromatic compounds include chlorobenzene, chlorotoluene, dichlorobenzene, and nitrotoluene. In embodiments, the solvent is a hydrocarbon solvent containing about 6 carbon atoms to about 28 carbon atoms. In more specific embodiments, the hydrocarbon solvent is an aromatic hydrocarbon containing from about 7 to about 18 carbon atoms, a linear or a branched aliphatic hydrocarbon containing from about 8 to about 28 carbon atoms, or a cyclic aliphatic hydrocarbon containing from about 6 to about 28 carbon atoms. In other embodiments, the solvent can be a monocyclic or a polycyclic hydrocarbon. Monocyclic solvents include a cyclic terpene, a cyclic terpinene, and a substituted cyclohexane. Polycyclic solvents include compounds having separate ring systems, combined ring systems, fused ring systems, and bridged ring systems. In embodiments, the polycyclic solvent includes bicyclopropyl, bicyclopentyl, bicyclohexyl, cyclopentylcyclohexane, spiro[2,2]heptane, spiro[2,3]hexane, spiro[2,4]heptane, spiro[3,3]heptane, spiro[3,4]octane, bicyclo[4,2,0]octanehydroindane, decahydronaphthalene (bicyclo[4.4.0]decane or decalin), perhydrophenanthroline, perhydroanthracene, norpinane, norbornane, bicyclo[2,2,1]octane and so on. Other exemplary solvents may include, but are not limited to, hexane, dodecane, tetradecane, hexadecane, octadecane, an isoparaffinic hydrocarbon, toluene, xylene, mesitylene, diethylbenzene, trimethylbenzene, tetraline, hexalin, decalin, a cyclic terpene, cyclodecene, 1-phenyl-1-cyclohexene, 1-tert-butyl-1-cyclohexene, methyl naphthalene and mixtures thereof. The term “cyclic terpene” includes monocyclic monoterpenes such as limonene, selinene, terpinolene, and terpineol; bicyclic monoterpenes such as α-pinene; and cyclic terpinenes such as γ-terpinene and α-terpinene. The term “isoparaffinic hydrocarbon” refers to a branched chain alkane.

In embodiments, the solvent is a low surface tension solvent. In this regard, surface tension can be measured in units of force per unit length (newtons per meter), energy per unit area (joules/square meter), or the contact angle between the solvent and a glass surface. A low surface tension solvent has a surface tension of less than 35 mN/m, including less than 33 mN/m, less than 30 mN/m, or less than 28 mN/m In specific embodiments, the solvent used in the silver nanoparticle composition is decalin, dodecane, tetradecane, hexadecane, bicyclohexane, an isoparaffinic hydrocarbon, and the like.

Some low surface tension additives can be added into the coating solution to lower the surface tension of the liquid composition for uniform coating. In some embodiments, the low surface tension additive is a modified polysiloxane. The modified polysiloxane may be a polyether modified acrylic functional polysiloxane, a polyether-polyester modified hydroxyl functional polysiloxane, or a polyacrylate modified hydroxyl functional polysiloxane. Exemplary low surface tension additives include SILCLEAN additives available from BYK. BYK-SILCLEAN 3700 is a hydroxyl-functional silicone modified polyacrylate in a methoxypropylacetate solvent. BYK-SILCLEAN 3710 is a polyether modified acryl functional polydimethylsiloxane. BYK-SILCLEAN 3720 is a polyether modified hydroxyl functional polydimethylsiloxane in a methoxypropanol solvent. In other embodiments, the low surface tension additive is a fluorocarbon modified polymer, a small molecular fluorocarbon compound, a polymeric fluorocarbon compound, and the like. Exemplary fluorocarbon modified molecular or polymeric additives include a fluoroalkylcarboxylic acid, Efka®-3277, Efka®-3600, Efka®-3777, AFCONA-3037, AFCONA-3772, AFCONA-3777, AFCONA-3700, and the like. In other embodiments, the low surface tension additive is an acrylate copolymer. Exemplary acrylate polymer or copolymer additives include Disparlon® additives from King Industries such as Disparlon® L-1984, Disparlon® LAP-10, Disparlon® LAP-20, and the like. The amount of the low surface tension additive may be from about 0.0001 wt % to about 3 wt %, including from about 0.001 wt % to about 1 wt %, or from about 0.001 wt % to about 0.5 wt %.

In embodiments, the liquid silver nanoparticle composition comprising the silver nanoparticles has a low surface tension, for example, less than 32 mN/m, including less than 30 mN/m, or less than 28 mN/m, or less than 25 mN/m. In specific embodiments, the liquid composition has a surface tension from about 22 mN/m to about 28 mN/m, including from about 22 mN/m to about 25 mN/m. The low surface tension can be achieved by using silver nanoparticles with a low polarity surface, by dissolving/dispersing silver nanoparticles in a low surface tension solvent, or by adding a low surface tension additive such as a leveling agent, or combinations thereof.

The silver nanoparticle composition or coating solution can be used to apply the silver nanoparticles onto any object. The object is simply drawn through the silver nanoparticle composition. The silver nanoparticle composition remains on the object as a uniform coating. In embodiments, the coating has a thickness of from about 50 nanometers to about 50 micrometers, including from about 50 nm to about 5 micrometers, or from about 80 nm to about 1 micrometer.

Next, the coating is heated to anneal the silver nanoparticles. This annealing causes the silver nanoparticles to coalesce to form a solid cladding of pure silver. In embodiments, the coating of silver nanoparticles is annealed at a low temperature of 250° C. or less, including 200° C. or less, or 180° C. or less, for example from about 100° C. to about 140° C. In other embodiments, the annealing is performed at a temperature of from about 80° C. to below 125° C. Regardless of the substrate used, the heating temperature is desirably one that does not cause adverse changes in the properties of any previously deposited layer(s) or the substrate (whether a single layer substrate or multilayer substrate). The annealing can be performed for a time ranging from for example about 0.001 minute to about 10 hours, particularly from about 0.01 minute to about 60 minutes, or from about 5 minutes to about 35 minutes. The annealing can be performed in air, in an inert atmosphere (for example, under nitrogen or argon), or in a reducing atmosphere (for example, under nitrogen containing from 1 to about 20 percent by volume hydrogen). The heating can also be performed under normal atmospheric pressure or at a reduced pressure of, for example, from about 1000 mbars to about 0.01 mbars. The term “heating” encompasses any technique that can impart sufficient energy to (1) anneal the metal nanoparticles and/or (2) remove the stabilizer from the metal nanoparticles. Examples of heating techniques may include thermal heating (for example, a hot plate, an oven, and a burner), infra-red (“IR”) radiation, a laser beam, flash light, microwave radiation, or UV radiation, or a combination thereof.

It should be noted that the term “annealing” generally refers to heating an article and then allowing it to cool. The term “sintering” usually refers to heating a powder below its melting point until the powder particles adhere to each other. However, the only real difference between these two terms is the size of the material that is heated. In this disclosure, the article to be annealed is the silver nanoparticles, which could also be considered to be powders. It is intended that the term “annealing”, as used herein, be synonymous with the term “sintering”.

Prior to heating, the coating of silver nanoparticles may be electrically insulating or have very low electrical conductivity. Heating results in an electrically conductive cladding layer composed of annealed silver nanoparticles, which increases the conductivity. In embodiments, the annealed silver nanoparticles may be coalesced or partially coalesced silver nanoparticles. It may be possible that in the annealed silver nanoparticles, the nanoparticles achieve sufficient particle-to-particle contact to form the electrically conductive layer without coalescence. The conductivity of the cladding layer produced by heating is, for example, more than about 100 Siemens/centimeter (“S/cm”), more than about 1000 S/cm, more than about 2,000 S/cm, more than about 5,000 S/cm, or more than about 10,000 S/cm or more than 50,000 S/cm.

In other embodiments, the cladding layer is not conductive. Although heating causes the coalescence of the silver nanoparticles, due to the presence of other additives or a residual amount of stabilizers and their decomposed forms in between coalesced particles, the cladding may not necessarily be conductive. However, the cladding has a silver color.

The resulting object having a silver cladding can be used in many different applications. Silver has several attractive properties including high conductivity, stability in ambient air, high density, anti-microbial activity, etc. Wires having a silver cladding can be used in several applications that take advantage of these properties, such as medical devices, electronics wiring, and other consumer products. For example, silver-clad copper wire could be used to replace solid silver wires in electronic switches and connectors requiring high conductivity and low contact resistance. The silver cladding can also be used to increase the weight of the object so that the silver-clad object has a dramatically different acoustic effect due to the density difference. The silver cladding also offers a more aesthetic visual appearance or optical effect. This simple solution coating process is also cheaper and easier to operate from a manufacturing viewpoint, which is an advantage compared to conventional plating processes.

The coating method described herein can also be repeated to build up a thicker cladding on the object. For example, in embodiments, the thickness of the final cladding may also be from about 50 nanometers to about 50 micrometers, or from about 50 nanometers to about 30 micrometers, or from about 50 nm to about 5 micrometers, or from about 80 nm to about 1 micrometer.

If desired, additional layers can be applied on top of the silver cladding (the additional layers may be referred to as overcoat layers). Any layer known in the art may be applied, particularly materials with good scratch resistance. In embodiments, materials that can be used to form an overcoat layer include an epoxy resin, a polyurethane, a phenol resin, a melamine resin, a polysiloxane, a poly(silsesquioxane), and the like. Polysiloxane and poly(silsesquioxane) precursors (for example sol-gel approach) can be used to from a highly crosslinked polysiloxane or poly(silsesquioxane) overcoat layer. In some specific embodiments, the overcoat layer is a crosslinked polysiloxane, a crosslinked poly(silsesquioxane), or a crosslinked layer comprising poly(vinylphenol) and a melamine-formaldehyde resin. The thickness of the overcoat layer may be for example from about 10 nm to about 10 micrometers, including from about 10 nm to about 5 micrometers, or from about 50 nm to about 1 micrometer. In embodiments, the overcoat layer is transparent to visible light. In other words, the overcoat layer is colorless. This will ensure the visibility of the silver cladding layer.

It is specifically contemplated that the processes used herein are suitable for cladding a wire. It should be noted that any wire can be coated with the silver nanoparticle composition, regardless of the diameter, shape, or length of the wire. Both organic materials (e.g. plastic) and inorganic materials (e.g. copper) can be used as the substrate for the wire. The wire may be bare (i.e. uncovered with other layers) or may be insulated by the addition of other layers around a core. The wire may be single-stranded (i.e. solid), multiple stranded, and/or twisted. Exemplary inorganic materials include metals such as copper, aluminum, tungsten, zinc oxide, silicon, and the like. Exemplary plastic wires include wires made from polyimide, polyester, polyamide (Nylor), polycarbonate, polyethylene, polyacrylate, and the like.

Optionally, a receiving layer can be applied prior to drawing the object (i.e. wire) through the silver nanoparticle composition. The receiving layer may enhance the adhesion of the silver nanoparticles on the object. Any suitable receiving layer can be used. Exemplary receiving layers can be formed from, for example, a silane, especially a silane comprising an amino group.

Disclosed herein is a wire having a ratio of the cross-section to the length of at most 2, including at most 0.1, or at most 0.001, wherein the wire has a silver cladding comprising fused silver nanoparticles, and an optional overcoat layer. It should be noted that the silver cladding formed from silver nanoparticles is different from the silver cladding formed by other methods such as plating or sputtering methods. The cladding from silver nanoaprticles comprises fused silver nanoparticles with a relatively smoother surface in contrast to silver particles formed by plating or sputtering methods. More importantly, there may be a residual amount of stabilizers or their decomposed forms present in the cladding layer. These unique features can be detected by various methods such as SEM, TEM, XPS or ToF-SIMS methods. In embodiments, the residual amount of stabilizers or their decomposed forms is from about 0.001 wt % to about 2 wt % of the total silver cladding, or from about 0.001 wt % to about 0.5 wt % of the total silver cladding. In embodiments, the wire is a plastic wire, and the overcoat layer is transparent.

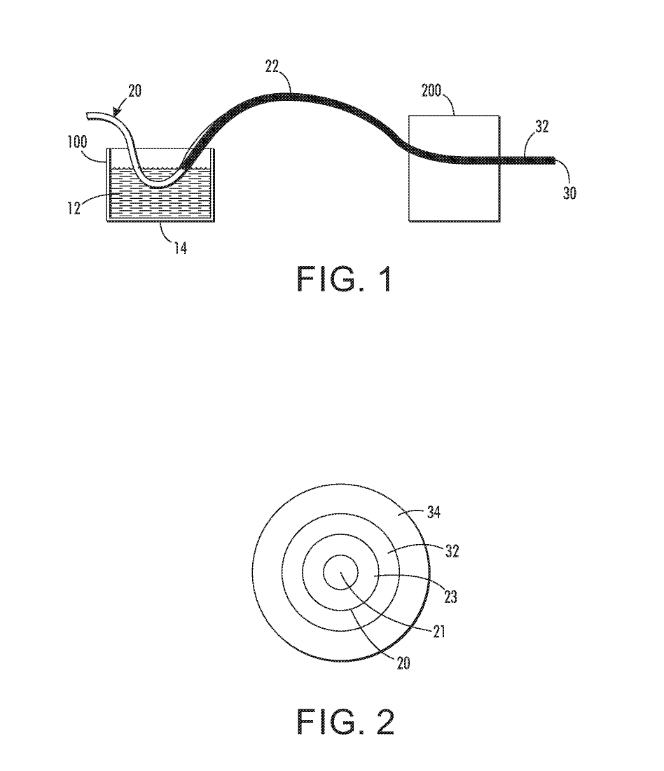

FIG. 1 is a schematic diagram illustrating the processes described herein. In step 100, a silver nanoparticle coating solution 12 is presented in a vessel 14. A wire 20 is drawn through the coating solution to form a coating 22 on the wire. Note that this allows for continuous production of the wire. Next in step 200, the coating 22 is annealed by exposure to heat. The result is a wire 30 having a silver cladding 32. The original wire 20 serves as a substrate upon which the cladding is located.

FIG. 2 is a cross-sectional view of the final wire 30. At the center is the original wire 20. As noted above, this original wire 20 may comprise a core 21 and other layers prior to receiving the silver cladding. For example, the original wire may include a receiving layer 23. Silver cladding 32 covers the wire 20. An overcoat layer 34 may surround the silver cladding 32.

It may be desirable to clean the wire prior to drawing the wire through the silver nanoparticle composition. This can be done by, for example, wiping the wire with isopropanol or using a plasma treatment on the surface of the wire. This will aid in maintaining a uniform coating and ensuring a 100% silver cladding.

The following examples are for purposes of further illustrating the present disclosure. The examples are merely illustrative and are not intended to limit devices made in accordance with the disclosure to the materials, conditions, or process parameters set forth therein.

### EXAMPLE 1

Dodecylamine-stabilized silver nanoparticles having a particle size about 5 nanometers were used to demonstrate the concept. The silver nanoparticles were synthesized using known methods. These silver nanoparticles can be annealed at 120° C. to obtain almost 100% pure silver.

A coating solution comprising 10 wt % silver nanoparticles in decalin was prepared by dissolving/dispersing the nanoparticles in the decalin, following by filtration with a 1.0 micrometer filter.

A plastic wire was cleaned and then pulled through a vessel containing the coating solution. A constant pulling rate was used to ensure uniform thickness of the resulting wet coating. After drying the solvent at room temperature, the coated wire was annealed in an oven at 120° C. for 10 minutes. A shiny silver cladding having a thickness of about 200 nm was obtained on the plastic wire.

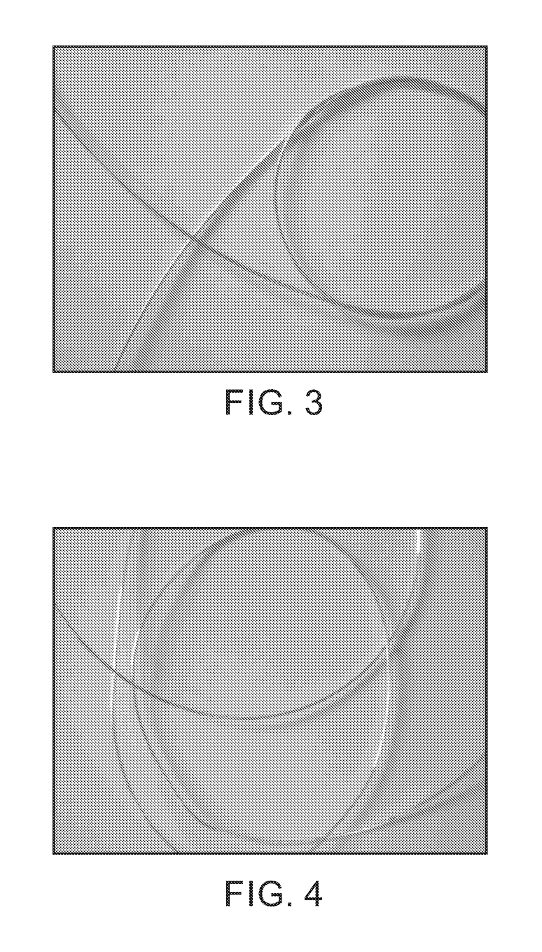

FIG. 3 is a picture of the silver-clad plastic wire obtained.

### EXAMPLE 2

To increase the mechanical robustness of the silver-clad plastic wire of Example 1, an overcoat layer comprising poly(vinylphenol) (PVP, Mw=25,000) and a melamine-formaldehyde resin as crosslinker was applied on top of the silver cladding. 2 wt % PVP in n-butanol was used. The ratio of crosslinker to the PVP was 0.8% to 1.0% by weight. After dissolving the PVP, the overcoat solution was filtered through a 0.2 micrometer filter before use. The overcoat layer was thermally crosslinked at 140° C. for 30 minutes.

It was noted that because silver changes the weight of the wires, the silver-clad wires of Examples 1 and 2 showed a dramatically different acoustic effect compared to an uncoated plastic wire. This may be useful in some applications, such as acoustic sensors.

### EXAMPLE 3

A copper wire was used to form the core of a silver-clad wire. After cleaning the copper wire, a silver nanoparticle coating was applied as described in Example 1. After annealing at 120° C., a shiny silver-clad copper wire was obtained with very low resistance. FIG. 4 is a picture of the silver-clad copper wire.

Copper is much less stable than silver, but is also much cheaper than silver. In electronic switches or connectors, silver wires are used due to their oxidation stability and high conductivity. Silver-clad copper wires would provide the same functionality as silver wire, while costing a fraction of silver wire, if the process for coating the copper wire is simple and low-cost.

The present disclosure has been described with reference to exemplary embodiments. Obviously, modifications and alterations will occur to others upon reading and understanding the preceding detailed description. It is intended that the present disclosure be construed as including all such modifications and alterations insofar as they come within the scope of the appended claims or the equivalents thereof.

1. A wire comprising a plastic core, a silver cladding comprising fused silver nanoparticles that surrounds the plastic core, and an optional transparent overcoat layer that surrounds the silver cladding; wherein a ratio of a cross-section to a length of the wire is 2 or less.

2. The wire of claim 1, wherein the silver cladding has a thickness of from about 10 nm to about 30 micrometers, and the transparent overcoat layer has a thickness from about 10 nm to about 5 micrometers.

3. The wire of claim 1, wherein a ratio of a thickness of the silver cladding to a thickness of the plastic core is from about 1:20,000 to about 1:100.

4. The wire of claim 1, wherein the plastic core is made from a material selected from the group consisting of polyester, polyimide, polyamide, polycarbonate, polyacrylate, and polyethylene; wherein the overcoat layer is present, and wherein the overcoat layer is a crosslinked layer comprising poly(vinylphenol) and a melamine-formaldehyde resin.

5. The wire of claim 1, wherein the overcoat layer is present, and wherein the overcoat layer is a material selected from the group consisting of an epoxy resin, a polyurethane, a phenol resin, a melamine resin, a polysiloxane, a poly(silsesquioxane), a crosslinked layer comprising poly(vinylphenol), and a melamine-formaldehyde resin.

6. The wire of claim 5, wherein the overcoat is annealed at a temperature of 250° C. or less.

7. The wire of claim 1, wherein the conductivity of the silver cladding produced by heating is more than about 100 Siemens/centimeter (“S/cm”).
